(19) United States
(12) Patent Application Publication
(10) Pub. No.: US 2016/0186719 A1
(43) Pub. Date: Jun. 30, 2016

(54) PSP WIND-POWERED GENERATOR COMPRISING BLADES AT DIHEDRAL ANGLES

(71) Applicant: Pedro SAAVEDRA PACHECO, Santa Anita-Lima (PE)

(72) Inventor: Pedro SAAVEDRA PACHECO, Lima (PE)

(73) Assignee: Saavedra Pacheco, Pedro, Santa Anita - Lima (PE)

(21) Appl. No.: 14/905,791

(22) PCT Filed: Jul. 15, 2014
(86) PCT No.: PCT/PE2014/000010

§ 371 Date: Jan. 16, 2016

(30) Foreign Application Priority Data
Jul. 17, 2013 (PE) 1565-2013/DIN

(51) Int. Cl. F03D 1/06; F03D 9/00; F03D 1/02

(52) U.S. Cl. CPC F03D 1/0641; F03D 1/025; F03D 9/002; F03D 1/0675

(57) ABSTRACT

The invention relates to a wind-powered generator comprising blades at dihedral angles (PSP), characterised by an aerodynamic, semi-flat blade having, on one if its sides, a bent section measuring approximately a quarter of the total width of the blade and forming a dihedral angle of less than 30°, the interior space of which captures the kinetic power of the wind impacting on the blade, thereby generating a powerful rotary movement in that direction. The blades form a diametrical set of two blades generating a strong and effective rotary movement at a 90° angle to the linear movement of the wind. The invention can be used to create: a generator comprising one single set of two blades; a generator comprising two sets of blades moving in one direction and generating an aggregate output; and/or a generator comprising two sets of blades rotating in opposite directions that generate twice the output of a set of blades rotating in one direction, with one single fixed and mobile structure, one single generator and one single wind mass.

### 1. PRIOR ART

The prior art in the field of wind turbines with horizontal shaft blades is concentrated on the improvement and enhancement of wind turbines with three aerodynamic blades, which have reached their technological limits, with a system consisting of the rotation of its blades at 90° to the direction in which the wind moves, and its production capacity which depends on high-velocity winds up to 150 m in height, which become more sophisticated with the improvement of its blades with aerodynamic shapes and new materials such as carbon fiber. These blades which break the kinetic power of the wind in spaces lateral to said generator due to their rotating position, prevent another set of blades from being installed on the same shaft, which this invention solves.

### 2. SUMMARY OF THE INVENTION

The invention which is intended to be patented in the field of renewable wind energy, has been developed with the purpose of obtaining more power from wind at the same or less height than the current aerodynamic blade turbines, which are currently the most productive and commercial in the world, which require high-speed winds that exist only at high altitudes and the technology of which is producing more electricity than their immediate predecessors.

This led the inventor to consider new possibilities with his technical resources gained with flat blades in his two previous inventions, one with a vertical shaft patented in the USA and another with horizontal shaft and extending blades, published by WIPO and in the national phase, both in a state of abandonment due to lack of capital to build commercial prototypes and to have them scientifically evaluated in order to present them to the market and serve humanity.

Having been designed on paper, said possibilities generated hypotheses that could be resolved and, if it is not proven that they are possible and true, it does not warrant patenting them. Since trial tests conducted by the inventor have shown their worth, we proceed to demonstrate its value as a potential product to produce more renewable energy and contribute to the fight against climate change which can only be mitigated or stopped with more production of renewable energy.
First hypothesis: That a flat wind turbine blade with acute dihedral angle on one side about a horizontal shaft can rotate at 90° to the wind.
Second Hypothesis: That two sets of blades with acute dihedral angles on one side can rotate about a single horizontal shaft in one direction of rotation.
Third Hypothesis: Two sets of blades at dihedral angles, with independent axes centered on a single mathematical shaft can rotate in opposite directions with the same wind mass as two sets with one direction of rotation.
Fourth Hypothesis: Two rotating shafts from two sets of blades with dihedral angle with double rotation can activate two magnetic fields of a double rotation electric generator, doubling the production of each set of blades with a single wind mass.

This requires the design and construction of new semi-flat blades that capture more kinetic wind power than the aerodynamic ones, retaining 50% of the wind that impacts as it hits the wind with the blade on its front side, of which two halves of the fluid go towards the two longitudinal sides of said blade which, in this invention, half is retained on the inside of the dihedral angle of the new blade, turning over this wind mass crashing against the inside of this minor side, with a driving force additional to that obtained with the traditional design.

For this purpose, a test prototype was designed and built, which was made up only of two elongated rectangular blades with a center hub to adjust a horizontal rotating shaft, of which two equal skies were built with lightweight aluminium sheet towards their ends, self-structured by a complete bend in a continuous straight side and on the other side an additional sheet bent at a dihedral angle approximately 30% of the width of the larger or main part. Set to operate at 90° to the direction of wind movement of a domestic fan, it demonstrated a perfect match with the hypothesis of the properties of increased rotational force of the new blades on the rotating shaft. As compared with a set of three aerodynamic blades, it showed higher velocity and balance. The three-bladed system proved to be slow, the new system with two dihedral angle blades has shown more smoothness and speed of rotation, which warrants submitting it for Invention Patent.

The second objective of the experiment was to analyse the amount of wind used by the two blades at dihedral angles and both are only long sections forming a diametrical rectangle in movement it was visible that even though they rotate at very high speed, it would always be proportional to that immense mass of untouched wind passing on both sides of the blades, keeping its kinetic power, which nobody is using intact It creates two new unavoidable technical objectives.

One, to run two sets of blades on the same horizontal shaft separated only by the gondola with its mechanical elements and conventional electric generator, if both were to rotate in the same direction.

Two, to run two sets of blades turning in the opposite direction on a single theoretical shaft, but each shaft incident on a double rotation electrical generator.

### 3. BRIEF DESCRIPTION OF THE DRAWINGS

Diagram 01—View of a wind turbine with blades at dihedral angles (PSP) for publication.

Diagram 02—Section of a conventional aerodynamic blade.

Diagram 03—Section of a blade at dihedral angle as tested.

Diagram 04—Section of a blade at dihedral angle as developed.

Diagram 05—Front view of a blade at dihedral angle as tested.

Diagram 06—Front view of a blade at dihedral angle for large generators.

Diagram 07—Front view of two blades at dihedral angles assembled at 180° to the circle of rotation.

Diagram 08—Front view of a set of two blades at dihedral angles in relation to the horizontal rotary shaft coming out of the gondola.

Diagram 09—Section of a blade at dihedral angle relative to the wind.

Diagram 10—Section in elevation of a wind turbine with two blades rotating in the same direction, about a single horizontal shaft.

Diagram 11—Front view of a set of two blades at dihedral angles crossed at the eye to rotate in the same direction, centred by a hub at the rotational shaft.

Diagram 12—Section in elevation of a wind turbine showing the incidence of the wind on the first and second set.

Diagram 13—Front view of two sets of blades at dihedral angles crossed and centered on a single common shaft, at dihedral angles on opposite sides in each set to rotate in opposite directions.

Diagram 14—View in elevation of a dual rotation wind turbine, showing the axes of opposite rotary movement from the blades to the double rotation generator.

### 4. SPECIFICATION OF THE INVENTION

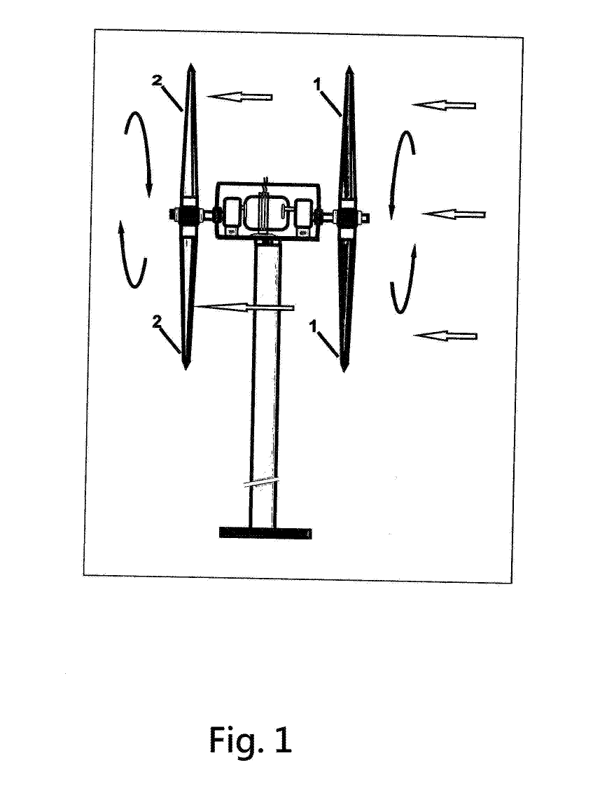

The invention developed experimentally and theoretically in its maximum expression worthy of being patented, is presented for publication purposes in FIG. 01 as a completely new double rotation wind turbine and with maximum production of renewable energy.

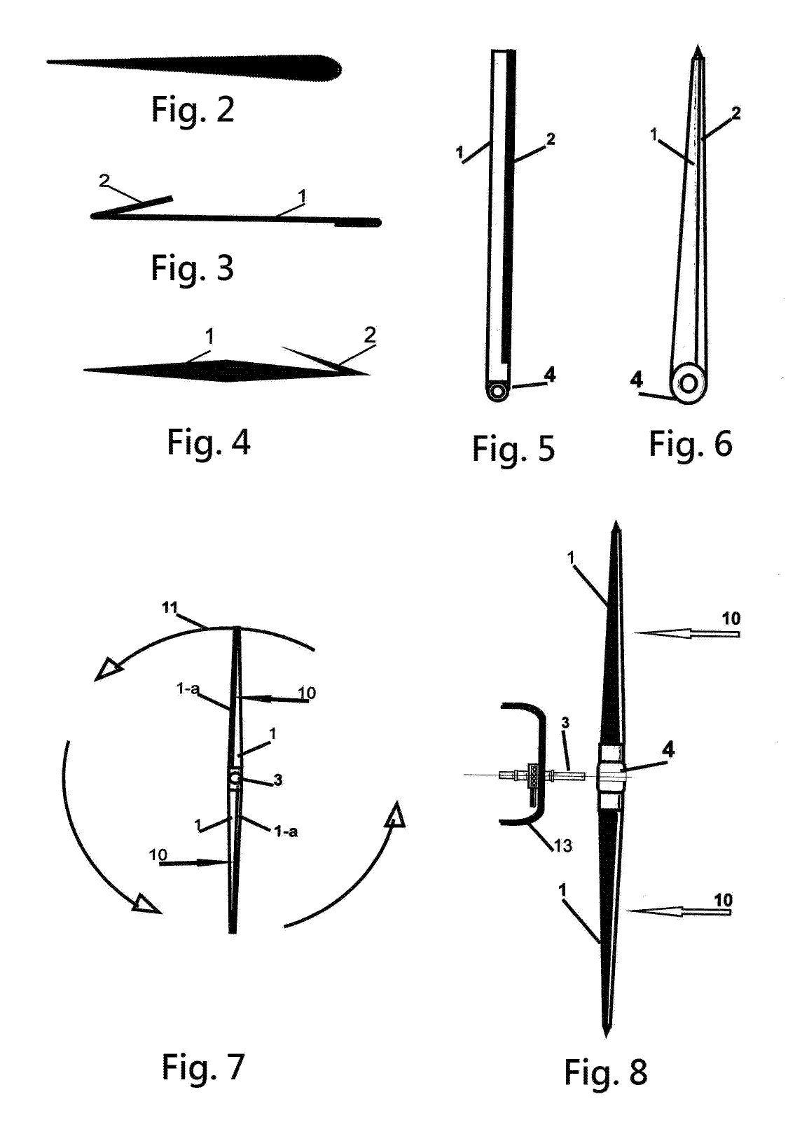

As this invention follows the objective of obtaining a greater production of electricity from the three conventional aerodynamic blades, the cross-section of which is shown in FIG. 02, a new blade was conceptualized for laboratory purposes. Said rectangular blade is 20 cm long, flat, as the hypothesis states and is shown in FIG. 03, is made of a bent lightweight aluminium sheet and tested with an office fan, for all purposes of the research process. Said rectangular sheet (1) with an additional dihedral angle (2), which is shown in FIG. 03 and FIG. 05, as it was manufactured and tested. The blade can remain in force for small or medium generators because it has more area of impact with the wind, proving more convenient in these proportions.

What has been presented up to here, solves the first hypothesis of obtaining rotary motion from a blade at dihedral angle about a horizontal shaft at 90° to the direction of wind movement, however longer wind turbine blades at higher levels of wind velocity are shown in FIG. 04, from a cross section of said blade (1), with a sharp conical shape toward both end sides, due to the necessary internal structure for blades of great length and weight, as well as the additional section at dihedral angle (2), and a complete developed blade for generators of great length and large production capacity that require acute conical form as shown in a front view in FIG. 06, where the blade (1), begins in the cylindrical hub (4) and tapers toward the tip and the additional dihedral profile can be seen in white on the right (2).

FIG. 07 shows a front view of two assembled blades paired with the sections (1), on the lower left and top right and the number two sections in the same uneven order, forming a diameter on the shaft (3), with the two blades (1), in diametric position, within the circle of rotation of the upper blade toward the left and the lower blade toward the right, powered by the wind (10) which drives them to the left and right to the smaller sides (1-a), when it deviates from the center of the blade towards the dihedral angle, generating a powerful circular rotary motion at 360° expressed by the arrows (11).

This figure can be objected stating that it is the same thing that aerodynamic blades do, but it is not true, because in said blades the wind is diverted to both sides of the blade freely, while in blades at dihedral angles one half the wind leaks and the other half does a special job of impulsion and does not leak, while the exterior vertex of the angle cuts the wind on that side reaching a high degree of rotation, shown in FIG. 08, where the rotary movement is transferred to the electric generator through the rotational shaft (3), to the engine room or gondola (13). Said shaft that would fit the hub (4), where the blades (1), viewed laterally, receive the thrust of the wind (10.)

Hypothesis No. 1 states that a flat blade at dihedral angle on one side about a horizontal shaft can turn at 90° to wind, which is considered solved with what was developed up to now and with the performance tests conducted with the test prototype, activated by the wind generated by the fan and the rectangular blades constructed with aluminium.

Second hypothesis: Two sets of blades at dihedral angles on one side can rotate about a single horizontal shaft in one direction of rotation.

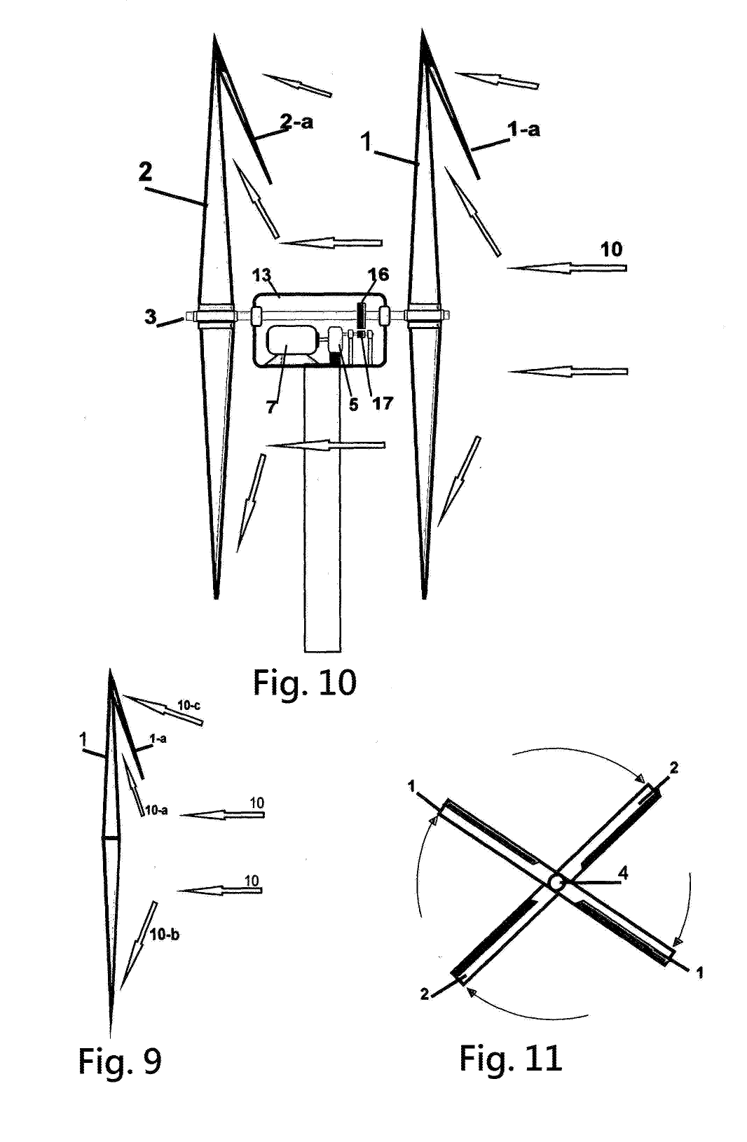

FIG. 09 shows the cross-section of a blade at dihedral angle and its relation to the wind (10) which strikes it directly on the central area of the blade but is displaced towards its two ends and is lost in the void, the tab (1-a), that connects with the upper end of the blade forming a dihedral angle and half of the mass of wind is directed towards its interior (10-a) striking the top half of the blade, while the wind does not find an exit and forcefully drives the entire blade to turn steadily toward that side, while the wind (10-c) more or less equivalent to a quarter of the mass of wind additionally hits the blade adding to the wind (10-a) and the wind (10-b) leaks into the void, generating a very effective rotary motion of the blade.

FIG. 10 presents two blades, displaying only the rear half of the two blades by accurate cross-sectional centre of the system's rotary shaft, so the two blades being aligned at the same point, present only one dihedral angle (1-a and 2-a) each in the upper edge of said blade. The two blades (1 and 2) are exactly similar because they are plotted one after the other for purposes of understanding their functionality, but in practice are adjusted at 90° from the other for maximum production. In the said figure, the rotary movements of the blades are shown which have the same direction, the mechanical torsional strength of which is transferred through the rotating shaft (3), by pinions (16 and 17), toward the speed gearbox (5) and hence eventually to the conventional electric generator (7).

Finally FIG. 11 presents two sets of exactly similar twin blades (1 and 2), crossed at the eye but focused on a single shaft by the hub (4), generating rotational movement in one direction like a clock striking the hour by the position of its dihedral angles which are crucial for that function.

Figures which confirm hypothesis two.

Hypothesis 3, argues that: Two sets at dihedral angles with independent shafts centered on a single mathematical shaft, can rotate in opposite directions, with the same amount of wind as two sets of blades in one direction of rotation.

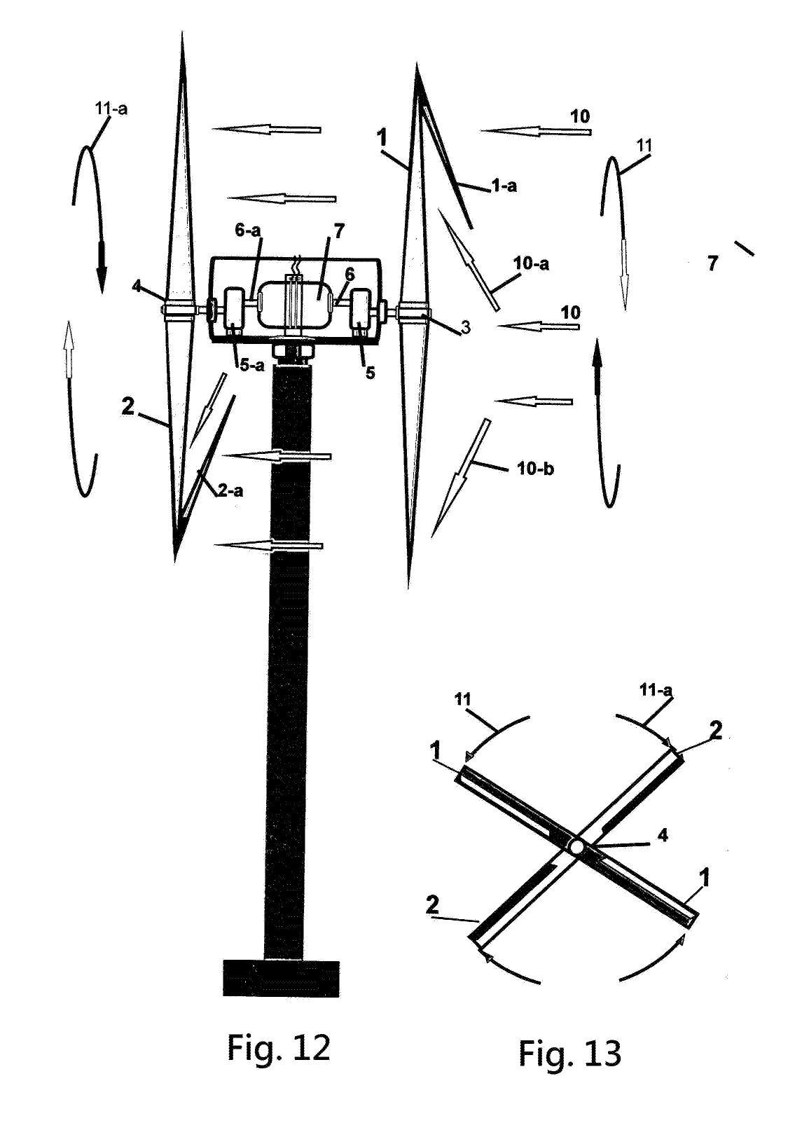

The tests were made with two sets of twin blades installed on a support column which contained two sets of double bearings centered on a single mathematical shaft, within which two equal rotating shafts of tubular steel rotated holding two sets of twin blades, tabbed or bent at dihedral angles as it is shown in FIG. 12, having a section of two opposite moving blades seen at 0° to its line of rotation, from the center of the rotary shaft (3) and of the entire system defined by the rotational arrows (11), for the blade (1) which receives the wind (10) and when it collides head-on with the blade, is divided in two directions, where the wind (10-a) is inserted within dihedral angle 1-a, driving the blade in this direction and the wind 10-b is lost in the vacuum.

The rotary movement of the shaft (3) is transferred to the multiplication box (5) and, through the shaft (6), to one of the fields of the double rotation electric generator (7), contributing 50% of RPM while the blade (2), located at the rear of the gondola with the dihedral angle at the bottom, shall have the same effect of the wind pushing it in the opposite direction, providing its rotary motion labelled by the arrow (11-a), hence through the shaft (3) toward the multiplier (5-a) and through the shaft (6-a) toward the other magnetic field of the electric generator, providing 50% of the remaining RPM for its operation. The 50% concept is only for reference, because in this case it is not necessary for there to exist equal RPMs in each set, this condition being indifferent, because RPMs, in case of inequality will always be equal to the sum of each shaft, that will always be higher than generators with rotors and stators ranging from zero to what the rotor alone produces.

FIG. 13, shows two sets of blades (1 and 2) at dihedral angles crossed at the eye centered by the hub (4) with its dihedral angles on different sides generating opposite rotational movements, indicated by arrows (11) and (11-a).

Figures showing tests performed solving the third hypothesis of this invention.

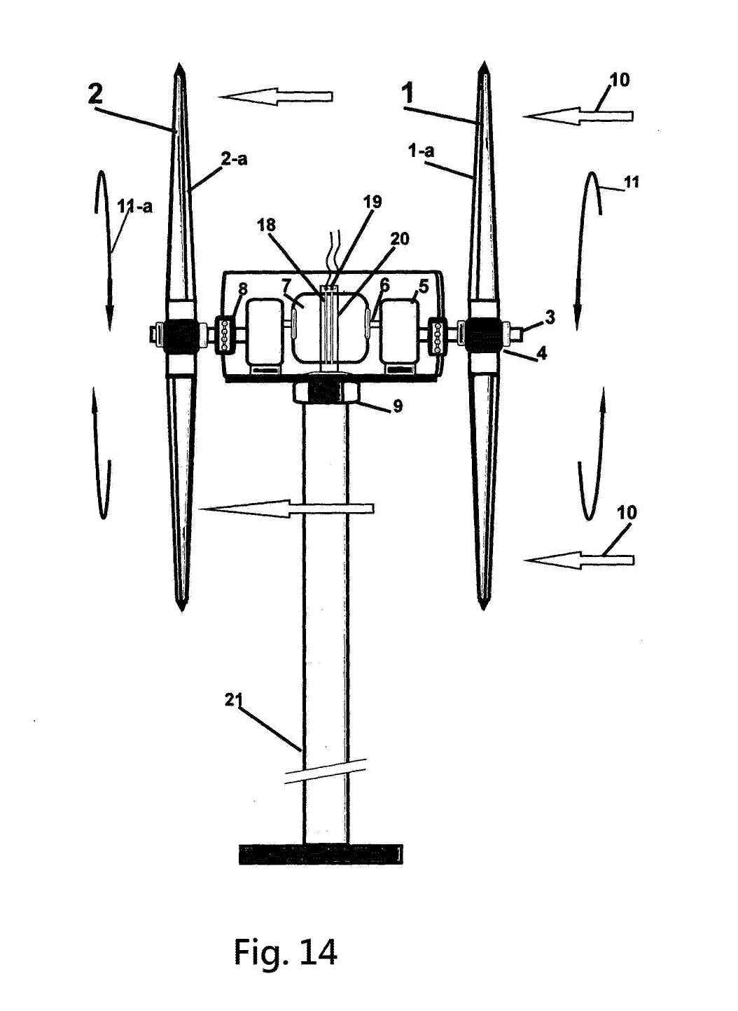

FIG. 14 shows an elevation of the same system as in FIG. 13 with the difference that in this case the complete system is shown, with the tower (21) which shows a gear system (9), supporting the gondola (13) containing all machines engaging the rotary movement and producing electricity and its shaft shall constantly orient itself on said gears in line with the movement of the wind by known electromechanical means. This Figure shows the blades (1 and 2), seen laterally with their decreasing longitudinal form, the set of blades (1) receiving the first impact of the wind and the blades (2), the impact of the wind which has passed to the other side without losing its kinetic power, because of the ample space left by the diametrical shape of only two blades.

Fourth Hypothesis: Two rotary shafts with two sets of blades at dihedral angles with opposite rotation can activate the two magnetic fields of a double rotation electrical generator, doubling the electrical output of each set of blades with a single wind mass. This hypothesis is resolved with the construction of a wind generator made up of two sets of blades at dihedral angles with physical shafts centered on a single mathematical shaft at the two ends of a gondola shown in FIG. 13, with permanent alignment at 0° to the direction of wind movement, the first blade (1) on the front or forward side of the generator and the second (2) at the rear side, each with their dihedral angles (1-a and 2-a), with opposite rotation, where the rotating shafts (3), transfer their rotary motion to the gearbox (5), and through the shafts (6), to the double rotation electric generator or alternator (7). But since the double rotation electric generator receives rotary drive from the two shafts with opposite rotation (6 and 6-a), each one of them affects an equivalent field: One affects the rotor and the other affects the stator. In this case both fields rotate or girate in opposite directions, adding their RPMs, which may be double and if it were not so, the total RPM will always be very high compared to a single set of blades, using for this purpose the same wind mass used by a generator with two sets of blades with one direction of rotation.

For better illustration, the same FIG. 14 shows the electric generator (7-a) afloat, without visible physical support, where the electric current (18) produced is collected by the carbons (19), suspended from an outer ring (20) that does not touch the generator at any time.

I have already claimed the double rotation electric generator in my “Marine Wind Generator with Extensible Blades” invention, where more than two sets of three blades can rotate in the opposite direction, by rotating in the same direction as the wind which does not alter the kinetic power of said wind mass in its lateral spaces of rotation, and is presented here only to illustrate how the duplication of electric energy is produced with blades at dihedral angles with opposite rotation, which in this case turn like giant tri-blades at 90° to the direction of wind movement with the same effect, but the source of rotation of which is not the same as the previous one and it has its own principle and support.

1. A Wind-Poster Generator With Blades At Dihedral Angles (PSP), characterized by an aerodynamic blade formed by two longitudinal sections with: A larger or main blade, semi-flat on both sides that captures the kinetic power of the wind turning at 90° to said fluid, and an additional smaller lateral one approximately a quarter of the larger width, fixed on one side forming an angle of less than 30°, said section is programmed to stop and capture the kinetic power of the wind which leaks to that side at the time of collision with this natural vector, provoking a great force of rotation in said direction, These blades assembled in a set of two at 180° to its horizontal shaft of rotation, resolve the hypothesis that: Two sets of parallel blades, one at the front and one at the back of an electric generator can double the production, Likewise, another hypothesis that: two sets of blades at dihedral angles centred on a single mathematical shaft may turn in opposite directions, activating both magnetic fields of a floating double rotation electric generator, doubling again the production of each set.

2. A Wind-power generator with blades at dihedral angles (PSP), according to claim 1, characterized by one aerodynamic blade composed of a section that is longitudinally semi-flat on both sides with a centrally thicker portion for structural reasons, said blade forming an acute dihedral angle less than 30° on one of its sides with a section equivalent to a quarter of the width of the blade, to capture additional kinetic power from the wind that drives it to that side, said dihedral angle with a sharp outer edge to cut the wind which likewise captures a fifth of the wind colliding with the entire blade at dihedral angles on its outer side.

3. A Wind-power generator with blades at dihedral angles (PSP), according to claim 2, characterized by producing directional rotary motion in the blade due to the position of the dihedral angle either to the left or right, when they are adjusted diametrically to a horizontal rotational shaft of a wind generator with blades at dihedral angles.

4. A wind-power generator with blades at dihedral angles (PSP), according to claim 2, characterized by its wide, semi-flat blades at the base or splice point with another blade forming a diametrical set with another, similar one, with decreasing lateral and longitudinal shape up to an acute angle at its opposite end, it can be assembled and removed at the horizontal rotary shaft for installation and maintenance.

5. A Wind-power generator with blades at dihedral angles (PSP), according to claim 2, characterized by the manufacture of dihedral blades in two ways: One for small and medium-capacity generators, with flat, rectangular blades made of aluminium self structured by bending and shaping. Two, for large generators with an internal longitudinal structure of aluminum, lined with the same material, fiberglass or stainless steel, filled with expanded polyurethane to prevent vibration and noise.

6. A Wind-power generator with blades at dihedral angles (PSP), according to claim 1, characterized by the rotary motion of two sets of blades about a single horizontal shaft, perpendicular to the blades and wind, with the same direction of rotation, by the same position of its dihedral angles in the two sets of blades, which determine a single direction of rotation of the blades at 90° to the wind, doubling the production of a single set of blades at dihedral angles.

7. A Wind-power generator with blades at dihedral angles (PSP), according to claim 1, characterized by the action of two sets of blades at dihedral angles centered on a single horizontal theoretical generator shaft: One, in the front part of the electric generator rotating in one direction and the other set in the rear part of the gondola rotating in the opposite direction activating the two magnetic fields of the double rotation electric generator, which duplicate its RPM, multiplying its capacity for electricity generation using a single mass of wind.
